(19) United States
(12) Patent Application Publication
(10) Pub. No.: US 2026/0036965 A1
(43) Pub. Date: Feb. 5, 2026

(54) System and Method for Controlling a Fleet of Semiconductor Process Systems Using Digital Twins

(71) Applicant: Yang Pan, SINGAPORE (SG)

(72) Inventor: Yang Pan, SINGAPORE (SG)

(73) Assignee: Inspiring Atoms Pte Ltd, SINGAPORE (SG)

(21) Appl. No.: 18/788,164

(22) Filed: Jul. 30, 2024

(51) Int. Cl. G05B 19/4099; G06N 3/08

(52) U.S. Cl. CPC G05B 19/4099; G06N 3/08; G05B 2219/45031

(57) ABSTRACT

Disclosed is a system and method for controlling and optimizing a fleet of semiconductor process systems using advanced digital twin technology. Each process system has a specific digital twin constructed from various subsystem digital twins and calibrated with real-time sensor data. An AI machine leverages these digital twins to create a fleet-level system digital twin. The AI machine continuously trains a policy neural network to autonomously generate and adjust process recipes. Both individual and fleet digital twins, incorporating statistical models, determine if a specific process system falls within the statistical distributions of the fleet, ensuring consistent and optimal performance.

### FIELD OF THE INVENTION

The present invention relates to the field of semiconductor manufacturing, specifically to systems and methods for controlling and optimizing semiconductor process systems using advanced digital twin technology. It involves the use of digital twins at individual process system and fleet level, enhanced by real-time data monitoring and AI-driven analysis, to autonomously generate and adjust process recipes, thereby improving performance and efficiency. The invention also includes identifying process systems operating beyond the statistical distributions of the fleet to ensure consistent and optimal performance across all systems.

### BACKGROUND OF THE INVENTION

In advanced semiconductor manufacturing, precise process control is critical to achieving high-quality outcomes and maintaining efficiency. As semiconductor devices become increasingly complex, the challenges associated with process control have intensified. One significant challenge is matching the outputs of many process systems within a fleet, ensuring consistency and reliability across all systems.

Traditional methods for process control rely on static models and manual adjustments, which are time-consuming, error-prone, and inadequate for the dynamic environment of semiconductor manufacturing. These methods struggle to adapt to real-time changes and variations, leading to suboptimal performance and inconsistencies in product quality.

Digital twin technology, which creates virtual replicas of physical systems for simulation and analysis, offers a promising solution. However, current implementations often lack the capability to continuously adapt based on real-time data and to coordinate multiple process systems within a fleet effectively.

The present invention addresses these challenges by introducing a system and method that use statistical digital twins at both the system and fleet levels. By leveraging real-time data and AI-driven analysis, the invention continuously calibrates and improves the digital twins, ensuring precise control and optimization of process systems. This approach helps to identify and rectify deviations, ensuring consistent and high-quality outputs across a fleet of semiconductor process systems.

### SUMMARY

This patent application discloses a control system and method for managing a fleet of semiconductor process systems through the use of digital twins. In some embodiments, each process system within the fleet is equipped with a system digital twin that is calibrated in real-time. These calibrated digital twins enable accurate control and monitoring of the process systems. The fleet as a whole is represented by a fleet-level digital twin that aggregates the operations of all individual systems.

A distinct feature of this invention is the use of statistical digital twins. A control module of the process system employs a statistical agent that determines the statistical distributions of subsystem parameters through continuous calibration. This calibration process is facilitated by a real-time monitor that captures the difference between the calculated state and the calibrated state of the process system. These differences help in identifying and adjusting selected subsystem parameters, which are then stored in a statistical database. The calibration process catches histories of the subsystem parameters in real-time. Each subsystem parameter may follow a distribution like a normal distribution.

An AI machine acts as the fleet controller, optimizing the operations of the entire fleet. Each process system has a system controller that is coupled to the AI machine through a communication link. The AI engine, a crucial component of the AI machine, is responsible for training a policy neural network using a reinforcement learning (RL) process. During this RL process, the neural network learns by evaluating actions against rewards to optimize the process recipe. An action in this context refers to a specific set of process parameters applied during a cycle of the semiconductor manufacturing process. The state is a description of the structures in the substrate being processed, including parameters such as depth, critical dimensions, and profiles.

The policy neural network, once trained by the AI engine, is transmitted to the system controller of each process system. This neural network autonomously generates process recipes by leveraging the system digital twin to optimize actions and outcomes. In real-time operations, the system controller uses the trained policy neural network to generate actions by continuously calibrating a calculated state based on real-time data from the RT monitor and adjusting the process recipe accordingly to achieve the desired substrate structure.

At the process system level, a process system statistical agent utilizes the system digital twin and real-time data to generate a statistical database of subsystem parameters. This statistical database captures the statistical distributions of the subsystem parameters, which are essential for accurate and efficient process control.

At the fleet level, the fleet statistical agent plays a pivotal role. The fleet statistical agent leverages the statistical digital twins of multiple process systems to construct the fleet-level digital twin. Using a random number generator, the agent selects a process system and generates the subsystem parameters according to their distributions. The Monte Carlo method is employed to generate many sets of inputs for the system digital twins, producing numerous output parameter sets for the substrates. The fleet statistical agent then analyzes these outputs to capture their statistical characteristics, which are stored in a fleet statistical database.

By comparing the statistical distribution of output parameters of individual process systems against those of the fleet, the fleet statistical agent can determine if a process system is operating within acceptable limits. If discrepancies are found, the agent identifies the problematic subsystem and parameter, enabling targeted adjustments and optimizations.

In some implementations, various subsystem digital twins are used, including RF, gas, temperature, chamber plasma, chamber surface aging, edge ring, and process digital twins. The computational efficiency of the system digital twin is enhanced through the use of neural networks. Additionally, the policy neural network autonomously generates process recipes, leveraging the system digital twin to optimize actions and outcomes.

This system and method represent a continuous improvement process by constantly calibrating the calculated state based on real-time monitoring. The process system-specific digital twin can be continuously improved by capturing the correct statistical distribution of the subsystem parameters. Similarly, the fleet-level digital twin can also be continuously enhanced based on improvements in the process system-specific digital twins. This ongoing calibration and improvement ensure that the semiconductor process systems operate at optimal performance, leveraging advanced digital twin technology, AI-driven analysis, and real-time data monitoring.

### BRIEF DESCRIPTION OF THE DRAWINGS AND TABLES

FIG. 1A: Illustrates a schematic diagram of an exemplary process system.

FIG. 1B: Showcases a schematic diagram of an exemplary control module of the process system.

FIG. 1C: Shows a diagram of functional blocks of a system digital twin.

FIG. 2A: Depicts a schematic diagram of a fleet of process systems.

FIG. 2B: Illustrates functional blocks of an AI machine.

FIG. 3: Presents a schematic flowchart of a system digital twin.

FIG. 4: Portrays a neural network representation for the system digital twin.

FIG. 5: Displays a process flow example using atomic layer etching (ALE), mapped for the RL processes to autonomously generate a process recipe.

FIG. 6: Shows a schematic representation of a policy neural network, integral to the RL process.

FIG. 7: Reveals a schematic diagram of an exemplary algorithm for RL, utilizing a Monte Carlo search tree (MCST) program to autonomously train a policy neural network.

FIG. 8: Illustrates a flowchart describing a process of autonomously training the policy neural network and generating a process recipe through the RL.

FIG. 9A: Showcases a flowchart describing a process for real-time calibration of a state and identification of subsystem parameters.

FIG. 9B: Illustrates a schematic diagram of a state calibration method.

FIG. 10: Showcases a schematic diagram of a flow where a statistical agent develops a statistical system digital twin.

FIG. 11: Depicts a schematic diagram of a flow where a fleet statistical agent generates a fleet statistical database for output parameters and subsystem parameters.

FIG. 12: Showcases a flowchart where a fleet statistical agent evaluates if a process system is delivering the output parameters within statistical distributions of the fleet.

Table 1: Outlines design parameters describing subsystem structures and topologies.

Table 2: Summarizes parameters that describe structures pre- and post-processing, using the ALE process as an example.

Table 3: Showcases selected ALE process recipe parameters, discretized into levels suitable for implementing RL.

### DETAILED DESCRIPTIONS

This section delves into the specific embodiments of the present invention, aiming to provide a comprehensive understanding. It is important to note that while certain implementations are described to illustrate the inventive aspects clearly, any alterations and modifications that fall within the scope of the appended claims are intended to be encompassed by this disclosure. These detailed descriptions underscore the innovative features of the invention, setting it apart from existing technologies.

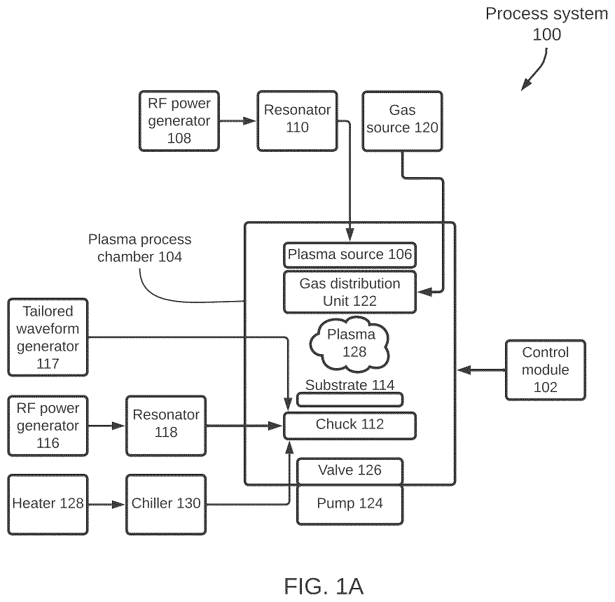

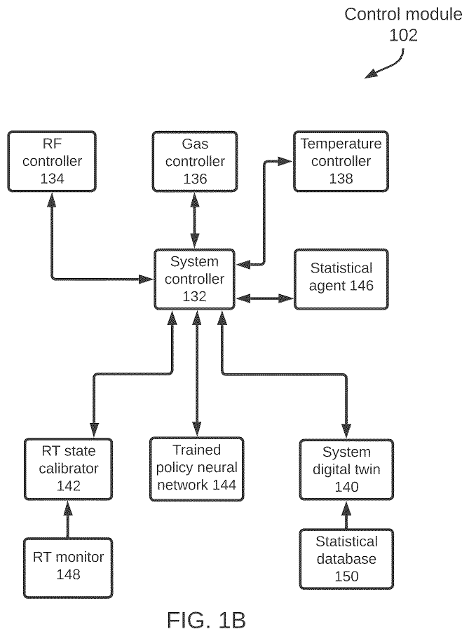

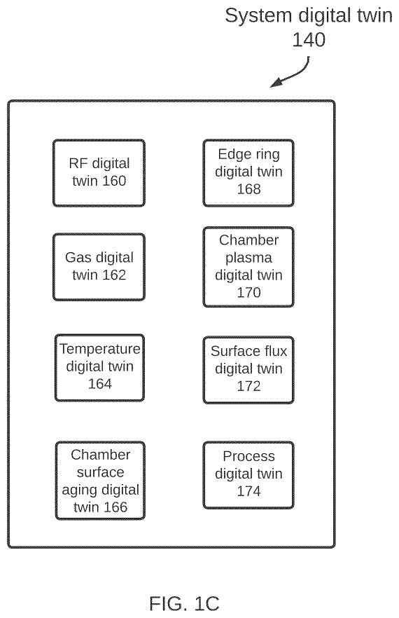

FIG. 1A illustrates an embodiment of a process system, designated as 100. The process system is generic for plasma-enhanced etching or deposition processes. For example, the process system 100 can be employed for reactive ion etching (RIE) or ALE. It can also be utilized for plasma-enhanced chemical vapor deposition (PECVD) or atomic layer deposition (ALD). In some cases, when subsystems related to plasma generation are absent, the process system becomes a thermal process system. The inventive concept presented herein is generic and can be applied to any type of semiconductor process system. The plasma-based process system with a vacuum chamber is used for illustration only and should not limit the scope of the inventive concept.

The process system 100 further includes a control module, denoted as 102. The components of the control module 102 are depicted in FIG. 1B.

The process system 100 includes a plasma process chamber 104, constructed to maintain a vacuum suitable for plasma processing. Within this system, a plasma source 106 is situated to receive radio frequency (RF) power from an RF power generator 108 via a resonator 110. The plasma source 106 may be realized in various configurations, such as an inductively coupled plasma (ICP) source or a transformer coupled plasma (TCP) source, among others.

The RF power generator 108 can operate at single or multiple frequencies—for instance, 13.56 MHz, 2.0 MHz, and 40 MHz may be used. The role of the resonator 110 is to match the output impedance of the RF power generator 108 with the impedance of the plasma process chamber 104, considering the impedance characteristics of the transmission lines. This resonator 110 typically comprises inductors and capacitors and may include mechanically adjustable capacitors. Alternatively, in other embodiments, the resonator 110 might exclude mechanically adjustable capacitors.

Impedance adjustments may be realized by varying the operating frequencies of both the RF power generator 108 and the resonator 110. During a process, the plasma is likely to exhibit variable states, which present different impedance levels. To maintain efficient energy transfer and minimize power reflection from the plasma process chamber 104 back to the resonator 110, it may be necessary to fine-tune the frequency for each distinct state of the plasma to ensure the resonator 110 remains in a resonating condition.

The plasma process chamber 104 is further outfitted with a chuck 112 that supports a substrate 114. The chuck 112 can be designed as an electrostatic chuck (ESC) or a vacuum chuck, depending on the process requirements. When an ESC is utilized, the chuck 112 is electrically connected to an RF power generator 116 via a resonator 118. Like resonator 110, resonator 118 requires tuning to a resonating state by adjusting its operating frequency. The operating frequencies of RF power generator 116 may differ from those of RF power generator 108. For instance, generator 116 may operate at a substantially lower frequency than generator 108. The RF power generator 116 provides a bias to the chuck 112. This bias is delivered through a blocking capacitor, which, while not depicted, is standard in the field. Alternatively, a tailored waveform generator 117 may be employed to supply a bias to the chuck 112. The tailored waveform can significantly narrow the distribution of ion energies produced by the ignition of plasma 128 within the process chamber 104. Depending on the implementation, the tailored waveform generator 117 may be connected to the chuck 112 alone or in conjunction with the RF power generator 116 and resonator 118 to provide the required bias.

The operation of the RF subsystem, including the RF power generators, resonators, and plasma source, is managed by an RF controller 134. This controller communicates with and is subordinate to a system controller 132. The RF controller 134 and the system controller 132 are components of the control module 102.

The plasma process chamber 104 incorporates a gas distribution unit 122, tasked with delivering process gases from a gas source 120 into the chamber. The gas distribution unit 122 can take various forms, such as a gas injector or a showerhead, and may include a side injection feature near the inner surfaces of the chamber body. The gas source 120 typically draws from a facility's gas supply through a gasbox and uses a combination of valves, pressure regulators, and mass flow controllers (MFCs) to regulate the gas flow into the chamber. In some other implementations, precursor delivery systems for delivering a precursor in gas, liquid, or even solid state may also be employed (not shown in the figure).

Additionally, the plasma process chamber 104 houses a pump 124, which may be a turbomolecular pump or another suitable type, designed to evacuate gases and by-products from the chamber. A valve 126, generally positioned atop the pump 124, modulates the evacuation rate from the chamber. The chamber pressure is monitored by a manometer (not illustrated), which triggers adjustments to the set point of an actuator of the valve 126 to maintain a pressure suitable for a vacuum-based process.

The gas distribution subsystem, also referred to as the gas subsystem, which includes the gas distribution unit 122, gas source 120, pump 124, and valve 126, is overseen by a gas controller 136. This controller is connected to the overarching system controller 132, ensuring integrated management of the process system 100. The gas controller 136 and the system controller 132 are components of the control module 102.

The plasma process chamber 104 is also equipped with a temperature control subsystem, also referred to as the temperature subsystem, to maintain the desired thermal conditions for the substrate and the chamber. In the embodiment exemplified in FIG. 1A, the temperature of the chuck 112 is regulated by a temperature controller 138, which operates a heater 128 and a chiller 130, as well as a temperature sensor (not depicted). The chuck 112 may be designed with multiple zones, each maintained at a distinct temperature. Additionally, temperature control for other components within the process chamber, such as the gas distribution unit 122 and various chamber surfaces, may be required and is implemented as is common in the industry. The temperature subsystem is controlled by a temperature controller 138 coupled to the system controller 132; all subsystem controllers are components of the control module 102 as shown in FIG. 1B.

The system controller 132 is equipped with capabilities to autonomously generate a process recipe by leveraging a system digital twin 140 and a trained policy neural network 144. The process recipe includes a chain of actions, each of which transforms the substrate from one state to another. For example, the state is a description of structures of the substrate being processed.

The system controller 132 is designed with advanced capabilities to calibrate a calculated state using an RT state calibrator 142 by leveraging data provided by an RT monitor. The RT monitor 148 comprises sensors for measuring subsystem, chamber, and substrate parameters in real-time. In some implementations, the RT monitor 148 includes sensors for measuring the status and performance of the RF, gas, and temperature subsystems. The RT monitor 148 may also include sensors for optical emission spectroscopy for characterizing neutrals in the plasma. The RT monitor 148 may further include sensors for optical reflectometry for directly measuring the structure progression of the substrate being processed.

A statistical agent 146 evaluates the difference between the calculated and the calibrated states over time and establishes a statistical database 150 which includes the statistical distribution of various subsystem parameters. Therefore, the system digital twin 140 can evolve into a statistical digital twin armed with the statistical database 150, which can be used effectively to predict the performance of the real-world process system 100. Every process system will possess a unique statistical database 150. The system digital twin 140 equipped with the process system-specific database 150 is also a process system-specific digital twin.

FIG. 1C depicts functional blocks of the digital twin 140. The system digital twin 140 comprises an RF digital twin 160 for simulating the operations of the RF subsystem, a gas digital twin 162 for the gas subsystem, and a temperature digital twin 164 for the temperature subsystem. Some chamber parts may have their surface conditions or dimensions affected by exposure to harsh plasma over time. Additionally, surface conditions can be altered by applying a preventive maintenance (PM) procedure, such as surface cleaning. Therefore, it is important to capture these effects by incorporating a chamber surface aging digital twin 166 and an edge ring digital twin 168. The system digital twin 140 further comprises a chamber plasma digital twin 170, a surface flux digital twin 172, and a process digital twin 174. The digital twins listed above are employed to predict structure progression in the substrate. The details of operations will be discussed in detail in the following sections.

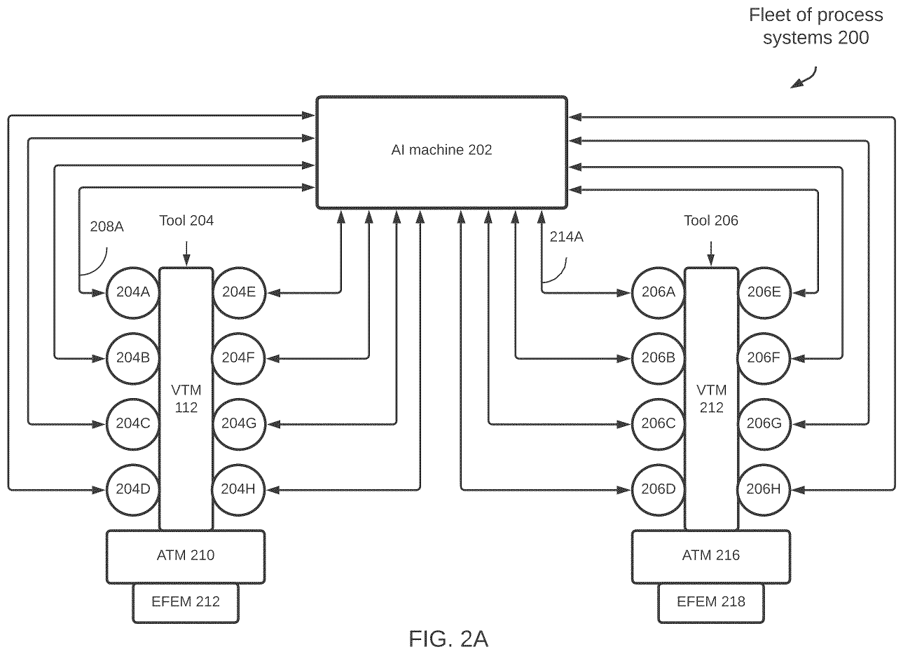

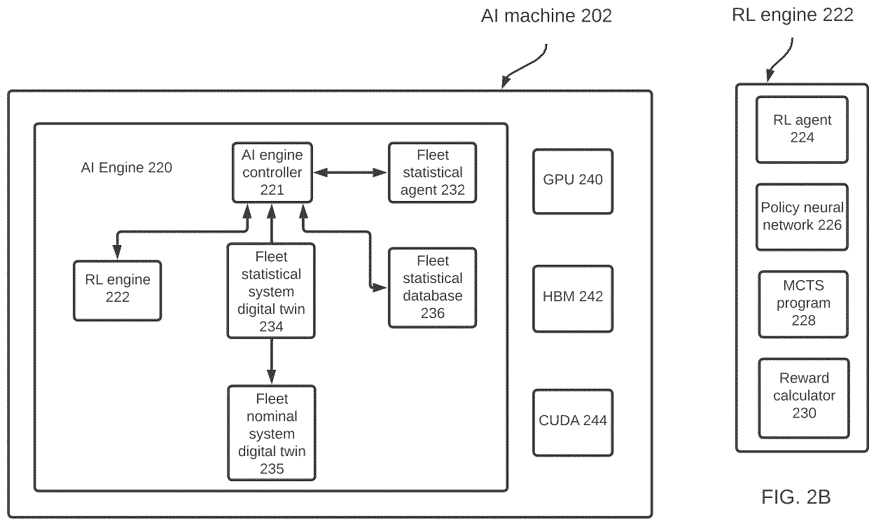

FIG. 2A schematically demonstrates a fleet of process systems, denoted as 200. A centralized AI machine 202 is employed as a fleet controller supporting operations across multiple process systems situated in various tools or platforms. Specifically, it exemplifies the AI machine 202's connection to a first set of eight process systems (204A to 204H) within tool 204 and to a second set of eight process systems (206A to 206H) within tool 206. Each process system is linked to the AI machine via communication links, listed as 208A for 204 and 214A for 206 as examples. The communication links can take various forms including, but not limited to, optical, wireless, and wired communication channels as known in the art.

The deployment of the AI machine 202 extends beyond controlling just two tools; it is adaptable to manage an assortment of tools, each possibly housing a varying number of process systems. Moreover, the tools interconnected with the AI machine 202 can encompass diverse types, particularly for etching and deposition process systems. The tools 204 and 206 further comprise atmospheric transfer modules (ATM) (210, 216) and equipment front end modules (EFEM) (212, 218).

The AI machine 202 includes at least two key functionalities. The first function is to train a policy neural network using the RL process to autonomously generate a process recipe. The second function is to establish a fleet-level system digital twin and use it to gauge if any process system in the fleet is performing outside the statistical distributions of the fleet. If such an event happens, the AI machine 202 identifies root causes of the mismatched performance.

FIG. 2B showcases a schematic diagram of an embodiment of the AI machine 202. In one implementation, the AI machine is a computer optimized for AI applications through advanced hardware and software modules. The hardware module includes advanced chips like a graphics processing unit (GPU) 240 and high-bandwidth memory (HBM) 242. These components are integrated using advanced packaging technologies to achieve the very high bandwidth required for AI applications. The software module further includes Compute Unified Device Architecture (CUDA) 244. These hardware and software modules enable the AI machine 202 to conduct highly efficient parallel computing, such as the algorithms used for RL.

The AI machine 202 also includes an AI engine 220, which enables autonomous operations for training a policy neural network used to generate a process recipe.

The AI engine 220 further comprises an AI engine controller 221, which controls operations of the AI engine. The AI engine controller 221 can be implemented leveraging the GPU 240, HBM 242, and CUDA 244. The AI engine 220 further includes an RL engine 222 responsible for autonomously generating a process recipe through an RL process.

A distinct feature of the AI engine 220 is characterized by a fleet statistical agent 232 which establishes the fleet statistical system digital twin 234 by incorporating inputs/outputs of the process system-specific digital twins. The inputs/outputs represent statistical distribution of each process system in the fleet. A large data set for the output parameters can be generated using the method like Monte Carlo algorithm which employs a random number generator to get a set of subsystem parameters. A fleet statistical database 236 is used to record both the subsystem parameters and the output parameters in a structured way. Based on the database, the statistical agent 232 can generate a fleet nominal system digital twin 235. In one implementation, the nominal system digital twin is created by utilizing nominal values of the subsystem parameters.

By comparing the output distributions of a specific process system to the distributions of the fleet by the statistical agent 236, the AI engine can gauge if the specific process system is operated within statistical distributions of the fleet.

The RL engine 222 further includes an RL agent 224, which is typically a software program stored in a storage medium of the AI engine controller 221 responsible for executing the RL process. A policy neural network 226 and an MCTS program 228 are employed by the RL agent 224 to build a search tree and to learn by evaluating actions against rewards. The rewards are calculated by a reward calculator 230 for each completed simulated case using the fleet nominal system digital twin 235.

The policy neural network 226 can be implemented as a software program executable by the AI engine controller 221. It may be implemented as firmware or hardware. In still other implementations, it may be implemented as a combination of software, firmware, and hardware. For example, the policy neural network 226 can be implemented as a hardware form of the neural network. The weights of the network 226 can be transmitted from the AI engine 220 to the connected system controllers. In one implementation, the trained policy neural network 226 can be implemented as an analog computing unit.

It should be noted that the fleet system digital twins 234/235 are constantly evolving. It may start from a generic representation of the process system based on simulation only. Subsequently, it acquires real-time data from all connected process systems and continuously improves its accuracy to represent the fleet statistically. The policy neural network 226 can be trained continuously at the fleet level and then be transmitted to a specific process system to be employed for generating process system-specific process recipes.

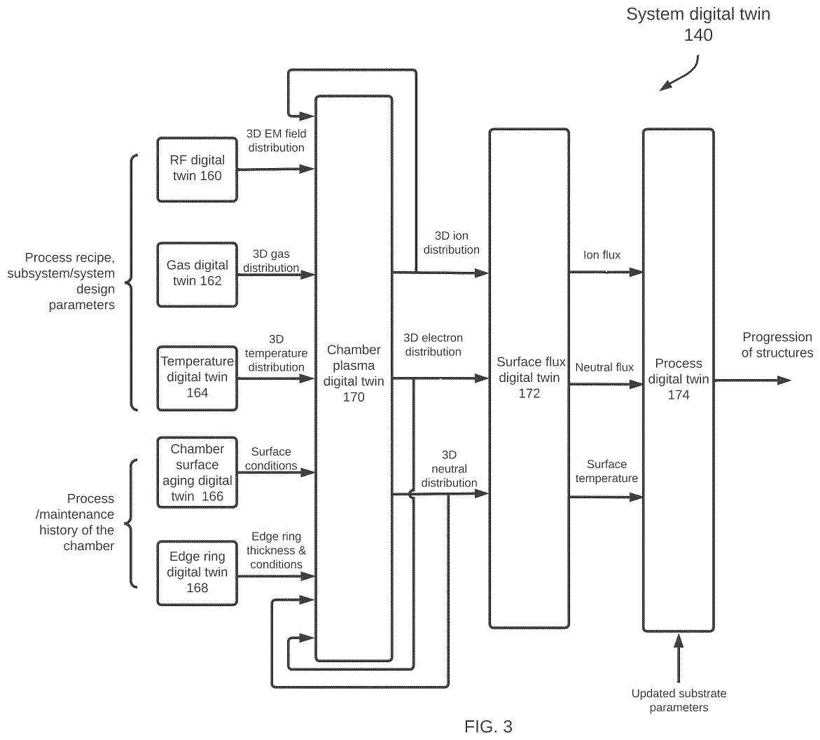

FIG. 3 illustrates schematically a flow diagram of the system digital twin 140. The RF digital twin 160, the gas digital twin 162, and the temperature digital twin 164 take related process recipe parameters and subsystem and system design parameters as their inputs. The RF digital twin 160 is designed to simulate the RF subsystem, which includes at least RF power generators and resonators. In some cases, it may also include a tailored waveform generator for the bias, although the tailored waveform generator is typically not operated in the RF range. In one implementation, the RF digital twin 160 includes a SPICE model for the RF circuits, which determines the RF power deposited into the plasma source during a time step. A Maxwell's equation solver is subsequently employed to compute the electromagnetic (EM) field distribution inside the chamber, considering the chamber structure parameters.

The RF digital twin 160 receives recipe parameters like RF power and initial operating frequency for the step. A set of system and subsystem design parameters, such as RF circuit topology, values of each component, structures, and parameters of the plasma source, and chamber structure parameters, are typically stored in a storage medium of the AI engine controller 221. A set of exemplary design parameters for the RF subsystem is listed in Table 1. The RF digital twin 160 can be used to determine the resonating frequencies of the RF subsystems. In another embodiment, more than one RF digital twin may be used. For example, the plasma source and the chuck bias may be modeled by different RF digital twins.

Similarly, the gas digital twin 162 replicates functions of the gas subsystem, encompassing elements like the gas source 120, the gas distribution unit 122, the pump 124, the valve 126, and the manometer (not pictured).

The gas digital twin 162 receives process recipe parameters like the flow rates of process gases. For example, for an ALE process, the gas digital twin 162 receives the flow rate for the first and second process gases and the chamber pressures for the surface modification step and the sputtering step, respectively. The design parameters for the gas delivery systems include the design parameters for the gas distribution unit as listed exemplarily in Table 1. If it is a showerhead, the design parameters will include its size, volume, distribution of injection channels/holes, and their sizes. The shape and size of the plasma process chamber are also important input parameters for the gas digital twin 162. The output of the gas digital twin 162 includes three-dimensional (3D) gas distribution (e.g., density, partial pressure, velocity, and residence time) inside the gas distribution unit 122 and in the plasma process chamber 104. In some implementations, the gas distribution along gas lines from the gas source 120 to the entry of the gas distribution unit 122 will also be modeled. The gas distribution can be simulated using methods based on fluid dynamics by leveraging finite element techniques or other advanced computational techniques.

The temperature digital twin 164 mirrors the temperature subsystem, which includes the heater 128, the chiller 130, and temperature sensors (not pictured). Besides the chuck temperature controls, it may additionally incorporate temperature regulation for other chamber parts such as the gas distribution unit 122.

The temperature digital twin 164 receives process recipe parameters like chuck temperatures. In some cases, the chuck 112 may be divided into zones, each with a different temperature specified by a process recipe. The input parameters to the temperature digital twin 164 further include design parameters for the heater and chiller as shown exemplarily in Table 1. For the heater 128, the design parameters include its locations inside the chuck or other chamber parts, as well as a range of its operating power. The design parameters further include thermal conductivity for various materials and their interfaces. For the chiller, the design parameters may include the type of coolants, flow rates of the coolants, and the number and locations of conduction channels. The temperature digital twin may apply numerical simulation methods like the finite element method to simulate the temperature distribution of the chuck, substrate surface, and inner surface of the plasma process chambers.

It should be noted that treating the digital twins 160, 162, and 164 independently may oversimplify the real world. For example, the RF power deposited into the chamber may affect the temperature of the substrate surface. Some of these interactions among different subsystem digital twins should be considered carefully.

The chamber interior surfaces and dimensions of certain parts are a function of time exposed to the plasma. The chamber surface aging digital twin 166 is used to model such “memory” effects for selected chamber surfaces like the surfaces of the window, the gas injector, or the showerhead. The input parameters include surface material, accumulated ion and neutral exposure, and treatment histories resulting from a PM procedure. The history of PM plays an important role in the conditions of the surfaces due to the cleaning procedures. The outputs include a set of surface parameters like surface structures, composition, roughness, and sticking coefficient. These parameters combined have effects on the chamber neutral and ion distributions.

The plasma process chamber 104 includes some consumable parts, whose dimensions may be reduced as a function of plasma exposure. Some of the changes may have significant impacts on the process performance. For example, an edge ring is typically employed along the edge of the substrate being processed to improve plasma and temperature uniformity in modern etching chambers. When exposed to the plasma for a period, a reduction in the edge ring thickness can alter the process performance at the edge of the substrate substantially. The edge ring digital twin 168 is used to model such effects. The inputs of the edge ring digital twin include the edge ring material, its structure parameters like the initial height of the edge ring. The input parameters further include the history of the edge ring being exposed to the ions and neutrals in the plasma. The history of PM can also be a factor. The outputs of the edge ring digital twin include the height of the edge ring. In some implementations (not shown in the figure), the temperature and electrical potential of the edge ring can be included as the input parameters to determine the edge ring erosion rate.

The outputs of the subsystem digital twins feed into the chamber plasma digital twin 170. During a specific time step of a process, the chamber plasma digital twin 170 models the plasma inside the chamber 104 and outputs 3D distributions of electrons, ions, and neutrals. The distributions at a specific time are a function of the EM field, gas, and temperature at that moment, as well as the distributions of electrons, ions, and neutrals prior to that moment. Therefore, the distributions of the electrons, ions, and neutrals need to be determined in a recurring manner. As shown in FIG. 3, the outputs of the chamber plasma digital twin from the current time step can serve as inputs for the same digital twin for the next time step. Each simulation event is for a predetermined time step defined by the AI engine controller 221.

After the 3D distributions of ions and neutrals are known, the surface flux digital twin 172 calculates and outputs the ion flux and neutral flux toward the surface of the substrate. Additionally, the digital twin 172 may output the surface temperature of the substrate by working together with the temperature digital twin 164. The plasma sheath above the substrate is critically important for determining the ion flux, which greatly impacts the etching behavior. The formation of the plasma sheath is well understood in the art and can be modeled accurately using the chamber plasma digital twin 170.

The outputs of the surface flux digital twin 172 feed into the process digital twin 174 to simulate the process in the plasma process chamber 104. The updated substrate parameters or its state serves as the inputs to the process digital twin 174. The current state of the substrate parameters is used by the process digital twin 174 to determine its outputs.

The flow depicted in FIG. 3 represents a snapshot of the process during the time step in the plasma process chamber 104. Therefore, the output of the process digital twin is a progression of the structures during the time step.

During each time step, the accumulated ion and neutral fluxes should be counted. Details of ion and neutral distribution are important for the process in the plasma process chamber 104. For ions, their energy and angular distributions during the step are critically important and can vary based on location on the surface of the substrate. The outputs of the surface flux digital twin 172 should include such critical details. Similarly, for neutrals, the density, thermal energy, and activation energy are important parameters for the substrate surface undergoing the process. It should be noted that the designs of the subsystem, chamber plasma, and process digital twins are exemplary herein. There could be many variations in implementation strategies. In some implementations, the chamber plasma digital twin and the surface flux digital twin could be combined into a single digital twin. In other implementations, the surface flux digital twin may be combined with the process digital twin. Additionally, the RF subsystem digital twin may be broken down into several digital twins to represent the plasma source and the bias units separately. Similarly, the temperature digital twin can be divided into two or more digital twins, with at least dedicated digital twins for the chuck and the gas distribution unit, respectively. All such variations are obvious and should fall within the inventive concept of the present inventions.

Implementations of the digital twins by neural networks can follow the same strategy of dividing the process system into subsystems.

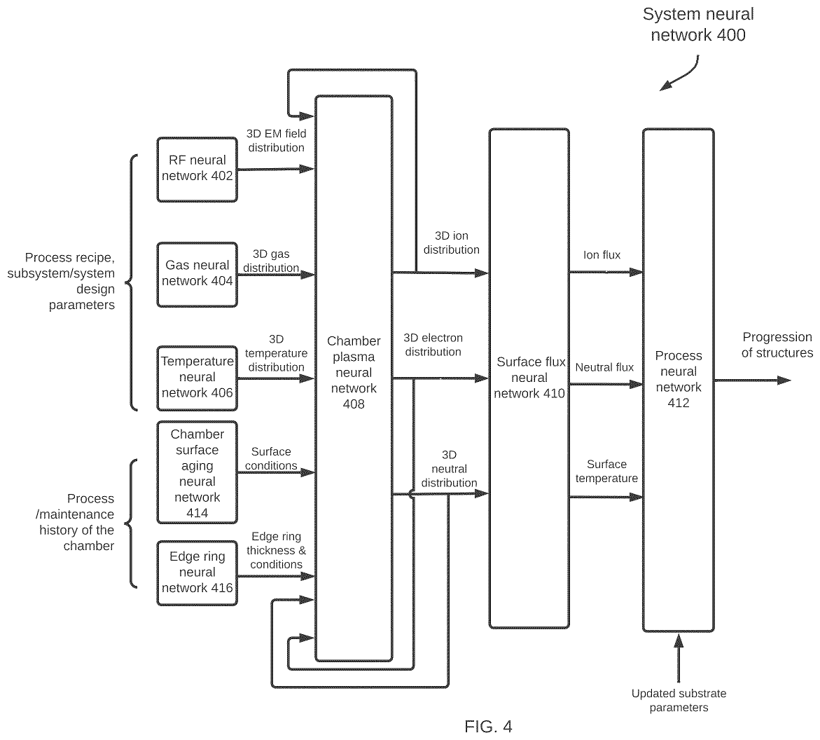

FIG. 4 illustrates an exemplary process system represented as a system neural network 400. In this embodiment, the subsystem digital twins are reconstructed using various neural networks. The RF digital twin 160 serves as the basis for training the RF neural network 402. Using the plasma source 106 attached to the RF power generator 108 and the resonator 110 as an example, one can begin by constructing a SPICE model to simulate the RF power generator 108 and resonator 110, including transmission line effects. The SPICE model outputs an initial AC current and voltage for coils of the plasma source 106, necessitating an assumed initial impedance for the plasma 128. Following this, a numerical simulator applies Maxwell's equations to predict the EM field distribution within the plasma process chamber 104.

The wealth of simulation data generated by the RF digital twin 160 becomes the training set for the RF neural network 402. The inputs for the neural network 402 include RF circuit topology and parameters such as the values of the inductors, capacitors, resistors, and transistors within the generator and resonator, along with detailed modeling of effects and transmission lines.

Furthermore, the RF neural network 402 considers the chamber structure parameters—dimensional specifics, positions of the chuck and the gas distribution unit, and material properties of these components, as listed exemplarily in Table 1.

Some parameters are measurable and thus provide a more substantial weight during the training of the RF neural network 402. For instance, sensors might track the current and voltage alterations in the coils of the plasma source or the reflected power at the resonator's output node. A B-dot sensor with multiple small coils could be positioned within the chamber to map the magnetic field distribution in an experimental setup. The information gleaned from these sensors not only informs the training process but ensures that the RF neural network 402 is closely aligned with the real-world behaviors observed.

Utilizing a neural network for modeling the bias portion of the RF subsystem focuses on the electric field generated initially in response to the applied RF power. Unlike the magnetic field concerned with plasma generation, the bias deals with the electric field affecting the substrate surface.

Transitioning to the gas dynamics within the process system 100, we approach the gas distribution neural network 404, which is informed by the gas digital twin 162. Numerical algorithms based on fluid dynamics are the foundation for determining the gas distribution within the chamber 104. This complex interplay involves the gas inflow from the gas distribution unit 122, the outflow managed by the pump 124 and the valve 126, which is influenced by the chamber's conductance and volumetric parameters. While numerical simulations offer accuracy, their demand for computational resources and time constraints necessitate a more efficient approach for real-time applications, hence the establishment of the gas distribution neural network 404.

The gas distribution neural network 404 is trained with simulation data reflecting various parameters, including the types and flow rates of gases, the design of the gas distribution unit 122, the pump's capacity 124, and the set point of the actuator of the valve 126, along with chamber dimensions and conductance. Some of the design parameters are listed in Table 1. The gas distribution unit 122, implemented as an injector, a showerhead, or a combination of both, can affect the gas distribution in the process chamber 104. The size, quantity, and distribution of channels/holes inside the injector and the showerhead are important design parameters. Gas pressure within the process chamber, monitored by a manometer, provides measurement data that enhances the training of the gas distribution neural network 404, often weighted more significantly than the simulation data to ensure the model's relevance to actual conditions.

Parallel to these developments is the creation of the temperature neural network 406, drawn from the temperature digital twin 164. This neural network is dedicated to mapping the thermal landscape within the plasma process chamber, particularly at the substrate surface. Its training originates from numerical models that simulate heat interactions and distributions. Inputs for the temperature neural network 406 include chuck and chamber parameters affecting heat generation and thermal conduction. In scenarios involving an ESC, the thermal characteristics of the ESC and the heat conduction efficiency, potentially affected by helium pressure used as a medium, are critical. Additional chamber specifications, such as size and construction materials, also influence the model. Temperature readings from sensors within the chuck 112 and the chamber 104 provide valuable real-world data, which, when used to train the temperature neural network 406, may carry heavier weights over simulated data due to their direct measurement of the physical environment. This balance of simulated and measured data ensures that the various neural networks closely mimic the actual processes, thereby enabling accurate predictions within the process system.

The chamber surface aging neural network 414 can be trained by the data generated by the chamber surface digital twin 166. Furthermore, the measurement data for specific chamber materials or surfaces can be generated utilizing specially designed testing apparatus and be used for the training. The neural network 414 mimics the digital twin 166 with significantly improved computing efficiency.

The edge ring neural network 416 can be trained by synthetic data generated from the edge ring digital twin 168. The erosion rate of the edge ring can be determined by measuring its height reduction against the time exposed to the plasma. The measurement data can then be used to improve the accuracy of the training.

FIG. 4 elucidates the intricacies of the system neural network 400, where the outputs of the subsystem neural networks mentioned above act as inputs to the chamber plasma neural network 408. The chamber plasma digital twin 170 serves as the foundation for the chamber plasma neural network 408, enabling a sophisticated representation of the plasma within the etching chamber.

To simulate the movement of particles within the plasma, either a Monte Carlo or a numerical plasma simulator can be used to visualize the three-dimensional distribution of electrons, ions, and neutrals. This is crucial because electrons, which are significantly lighter, move more rapidly than ions, leading to the creation of a sheath on the surfaces within the chamber. This sheath plays a pivotal role in ion acceleration toward the substrate, a process essential for sputtering but potentially counterproductive during surface modification when an ALE process is applied.

The training of the chamber plasma neural network 408 integrates simulation data for faster computation and higher efficiency. However, to refine its predictive capabilities, it may also assimilate measurement data gathered from sensors within the chamber, such as optical emission spectroscopy and hairpin sensors that gauge electron density. This measurement data may be given a heavier weight over the simulated data to ensure that the outputs of the plasma neural network 408 are as realistic as possible.

The dynamic nature of the plasma environment is captured by the recurrent neural network (RNN) design of the chamber plasma neural network 408. This means it can process temporal sequences, taking snapshots of plasma conditions at a given time and incorporating them into the model for future predictions. It is an ongoing cycle where the neural network's previous outputs become part of the input data for the next time step, mimicking the continuous evolution of the plasma state.

Once the chamber plasma neural network 408 has computed the 3D distributions, the ion and neutral fluxes to the substrate surface can be determined based on a surface flux neural network 410. The ion and neutral fluxes, along with the surface temperature of the substrate, are then taken as inputs for the process neural network 412. The process neural network 412 can be trained based on the data generated by the process digital twin. The outputs of the process neural network 412 further include the progression of the structures in the substrate.

Ultimately, the chamber plasma neural network 408 and the surface flux neural network 410 yield valuable outputs beyond just fluxes; they also provide critical insights into the surface temperature by working together with the temperature neural network 406. The accumulated fluxes during the time steps should also include valuable information about ion energy and angular distribution, as well as neutral thermal energy and activation energy. These parameters are essential for fine-tuning the process in the plasma chamber to achieve the desired etching precision and substrate surface quality.

It should be noted that FIG. 4 showcases an embodiment 400 of a full neural network implementation of the system digital twin 140. In other embodiments or implementations, some functional blocks may not be implemented as neural networks. For example, the surface flux neural network 410 may be an analytical model. Hence, embodiment 400 is exemplary. There may be many variants of implementations by combining models, lookup tables, analytical models, numerical models, and Monte Carlo models for selected building blocks of the system digital twin 140. All such variants fall within the scope of the present inventive concept.

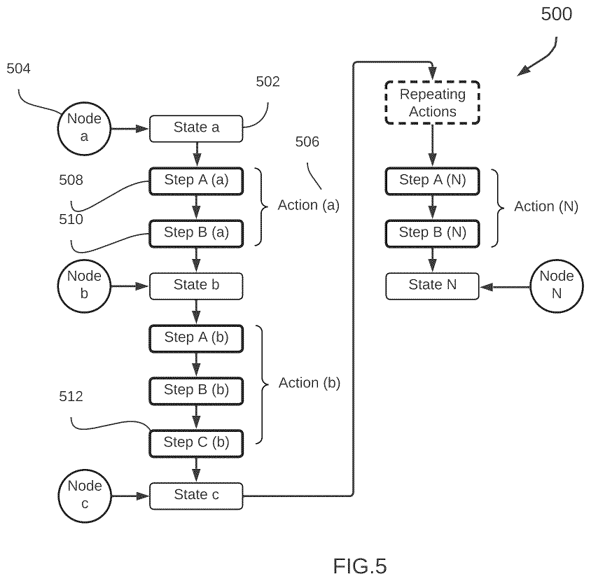

An ALE process is employed herein as an example to illustrate a system and method for autonomously generating a process recipe through the application of an RL algorithm. FIG. 5 illustrates an ALE process flow 500, which is suitable for implementing the RL algorithm. An exemplary ALE process typically involves alternating between a surface modification step A and a sputtering step B in a cyclic manner. It should be noted that steps A and B herein are commonly called half cycles of the ALE process, which are different from the time steps we discussed previously for simulating plasma behavior in the chamber. The time steps are significantly shorter than step A and step B of the ALE process.

During step A, the surface of the substrate 114 is chemically altered using chemically active neutrals formed in the plasma, which is generated by a plasma source powered by an RF power generator. A halogen gas, such as chlorine, is often introduced to produce neutrals for this purpose. During this surface modification step, the bias to the chuck is typically set to zero to minimize the impact of ions on the substrate, thereby preserving the integrity of the ALE process.

Conversely, during the sputtering step B, an inert gas like argon is introduced to generate energetic ions that physically remove the chemically modified layer from the substrate by sputtering. During the step B, a bias is typically applied to the chuck through the RF power generator and resonator.

Between these steps, a purge step may be employed to transition the gases from step A (508) to step B (510) or vice versa without intermixing the two process gases. The purge steps are not shown in FIG. 5. Step A (a) shown in FIG. 5 represents step A at the node a. Similarly, step B (a) represents step B at node a.

In some applications, particularly when etching high aspect ratio structures, an additional deposition step C (512) can be optionally included along with steps A and B. This step C is strategically inserted into the ALE cycle sequence but at a less frequent rate compared to steps A and B. Its primary function is to protect the sidewalls of the etched structures, thus preventing lateral etching that may arise due to the angular distribution of the ions. Step C (b) represents step C at the node b.

An ALE process runs in cycles, with each cycle including a step A and a step B. As shown in FIG. 5, an ALE cycle starts from a state and completes in another state. A state is denoted as 502, which describes the substrate undergoing processing. State a represents the state at the node a. Specifically, in an ALE process, the state describes one or multiple structures. The description of the state includes, but is not limited to, parameters describing a structure being etched, such as depth, critical dimensions, profiles, and loadings as shown exemplarily in Table 2. The state 502 is associated with a node 504. Hence, state a is associated with the node a. The ALE cycle starts initially at a node with a state, executes an action, denoted as 506, by selecting process recipe parameters using the policy neural network 226 and MCTS program 228, and completes at another node with an updated state. In FIG. 5, Action (a) denotes the action triggered by the ALE recipe at the node a.

It should be noted that a node can lead to more than one node through different actions. If the recipe parameters are continuous, the available new nodes would be infinite. Conversely, if the recipe parameters are discretized to limited levels, the available new nodes will be limited.

A complete ALE cycle is used for an action in FIG. 5 as an example only. In some other implementations, a half cycle can be employed to separate the nodes. In such a case, the action is either a surface modification step A, a sputtering step B, or even a deposition step C. All such variations will fall within the scope of the present inventive concept.

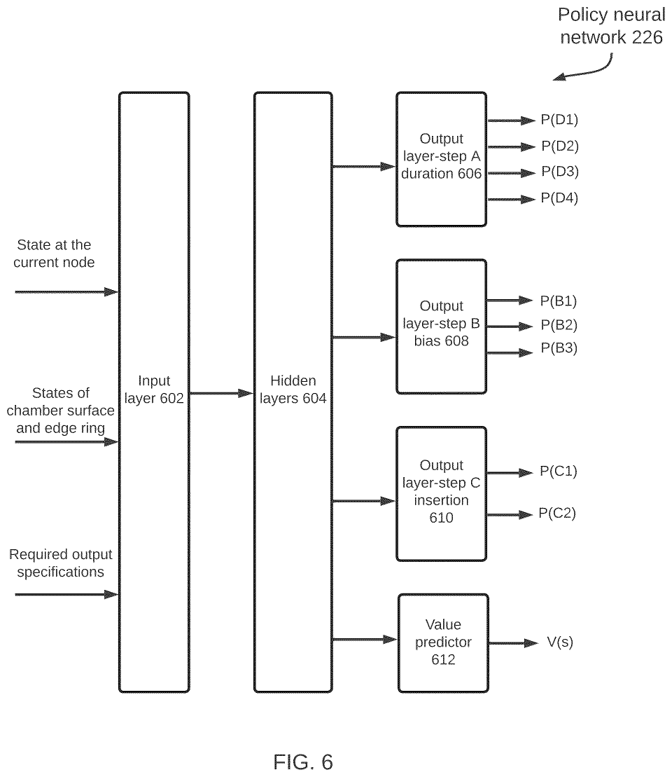

FIG. 6 showcases an exemplary policy neural network 226. The network 226 comprises an input layer 602 for receiving the state of the current node and required output specifications as its inputs. For real-time modeling using the system digital twin 140, it is critically important that chamber parameters, which are a function of the chamber age exposed to the plasma, should be included as an input of the policy neural network 226. In the context of the present invention, the outputs of the chamber surface aging digital twin 166 and the edge ring digital twin 168, which describe the real-time state of the chamber interior surface and the edge ring height, are inputs for the policy neural network 226. Hence, it can be used effectively to predict the actions from the state. It should also be noted that the output specifications herein are final requirements after completion of the entire process, not a step of the process. Inclusion of the output specifications as one of the inputs of the policy neural network 226 makes it more generic and able to deal with changes in output specifications. In some other implementations, the inputs include only the state.

The policy neural network 226 further includes one or more hidden layers, denoted as 604, for processing received data from the input layer 602. The policy neural network 226 further comprises an output layer, which may include multiple parts, each part further including several parameters describing softmax or logistic functions. The parts of the output layer are depicted in FIG. 6 as 606, 608, and 610 exemplarily, each delivering a probability distribution of a discretized process recipe parameter with more than one level. Furthermore, the output layer includes a value predictor 612 for predicting the value V(s) of the state based on the current policy represented by the policy neural network 226 with the current weights.

FIG. 6 exemplifies the policy neural network designed for the ALE process, wherein three recipe parameters are selected. The first part 606 delivers probability distributions of 4 levels of the duration of step A, denoted as D1, D2, D3, and D4, where P(D1), P(D2), P(D3), and P(D4) are the probabilities of each level, respectively. A softmax function can be utilized to describe such 4-level probability distribution with 4 output parameters. The probability can then be calculated accordingly. Similarly, the second part 608 outputs probability distributions of 3 levels of the chuck bias of step B. The third part 610 delivers probability distributions of 2 possibilities for either including or excluding a step C after step B in the ALE cycle. The two-level probability distribution can be represented by a logistic function. Exemplary ALE recipe parameters for this implementation are depicted in Table 3. The exemplary input parameters are listed in Table 2.

It should be noted that different sets of ALE recipe parameters may be selected, and different levels may be selected for each parameter. If the process system 100 is employed for a different type of process like deposition, the parameter selection may be different. The example herein is for illustration purposes and should not be considered a limit for the inventive concept. Furthermore, the selection of the recipe parameters and levels may be dynamic. It means they may be modified during the execution of an RL algorithm. In one implementation, after a predetermined number of simulated cases are executed, the RL agent 224 may decide to narrow down the parameter space and adjust ranges and levels of the parameters to accelerate the convergence of the RL algorithm. In some implementations, old parameters may be removed, and new parameters may be added. In still some other implementations, the entire set of recipe parameters may be selected and determined through the execution of the RL algorithm. The ranges of the parameters are related to subsystem capability and capacity and are stored in the storage medium of the AI engine controller 221 of the AI machine 202.

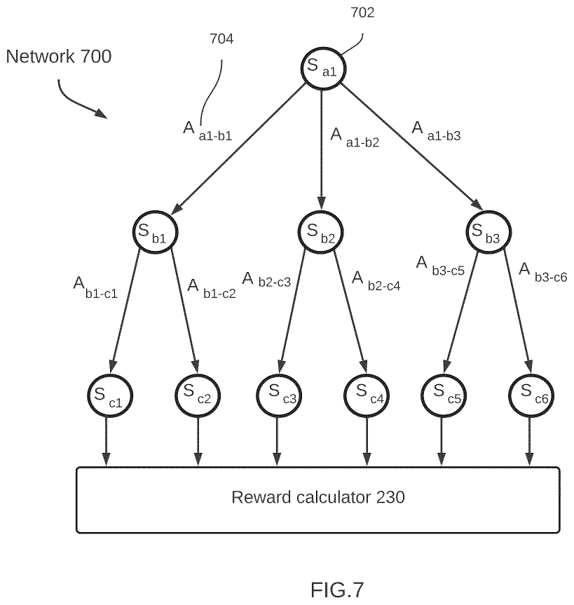

FIG. 7 schematically reveals a network 700 resulting from the RL process being rolled out through the MCTS algorithm. As shown in FIG. 7, nodes like node 702 are represented by circles. Each node is associated with a state, such as Sₐ₁. A parent node can lead to multiple child nodes upon the execution of actions such as 704. For example, the node with the state Sₐ₁ can transit into a node with the state S_{b1} resulting from the action A_{a1-b1}. The RL agent 224 manages the selection process through the policy neural network 226 and the MCTS program 228. For the ALE process, each action represents one ALE cycle with selected process recipe parameters although a half cycle could also be an option. The selection of an action continues until reaching a terminal state where criteria are met to calculate a reward by a reward calculator 230. For example, in the case of an ALE process, the reward may be calculated when a specific etching depth is reached.

A reward can be designed based on a cost function. A cost function for the ALE process is typically formulated as a squared function pertaining to each output parameter of the structure post the ALE processing. The cost function can be defined as:

$$c = {{\sum }_{i = 1}}^{N} {{w}_{i} ( {p}_{i} - {p}_{itarget} )}^{2} , \qquad [ 1 ]$$

where c is the cost, wᵢ is the weight, and pᵢ is a normalized output parameter like critical dimension at a selected vertical coordinate, p_{itarget} is the normalized target value of the output parameter, and N is serial number of the parameter. If multiple structures are evaluated, the cost function can be further expressed as:

$$C = {\sum }_{j = 1}^{M} {W}_{j} {c}_{j} , \qquad [ 2 ]$$

where C is the accumulated cost across multiple structures, Wⱼ is the weight, and cⱼ is the cost for one of the structures. The method can take several or many structures across a substrate like a 300 mm wafer. The method can further take different structures or different parts of the structure to quantify various loading effects. A reward can be designed as:

$$R = f ( c ) , \qquad [ 3 ]$$

Where R is the reward, and f is a function for determining the reward based on the cost c. In one implementation, the reward may be designed as multiple, or many discrete numbers based on the cost. For example, the range of the cost can be divided into 10 intervals. Each interval is represented by an integer.

Each time the RL process reaches the terminal state, the reward can be computed. Each state-action pair like (Sₐ₁, A_{a1-b1}), which is a part of state-action chain for the test case to receive the reward. A visit count for the pair will also be updated. After enough test cases are executed and an episode is completed, the average reward associated with each state-action pair can be calculated as the accumulated reward divided by the visit counts.

The value associated with a node can then be calculated by averaging the reward across all state-action pairs originating from the node. These data can be employed to train the policy neural network 226 to be more focused on generating actions with higher rewards.

In some implementations, the RL algorithm can be designed to be biased toward exploration rather than exploitation. For example, in a new episode for RL, the initial weights for the policy neural network can be assigned randomly. This can be a useful technique to prevent the RL process from being trapped in a local optimal point in the process recipe parameter space.

In other implementations, techniques like the ε-greedy algorithm may be employed to expand the search tree. The algorithm allocates a part of the probability distribution to a completely random distribution and is well known in the art.

The ALE example provided is for illustration only. For a real RL process, the number of nodes could be substantial. The weights will be updated continuously to narrow down the selection of actions until the policy neural network 226 becomes deterministic. Subsequently, a process recipe can be generated for real-world applications.

The system digital twin 140 is used in the RL process as the backbone of the simulation. The neural network version 400 of the digital twin 140 can improve the computational efficiency greatly. In one implementation, a generic system digital twin or its neural network version may be applied. In another implementation, the fleet nominal system digital twin 235 can also be utilized.

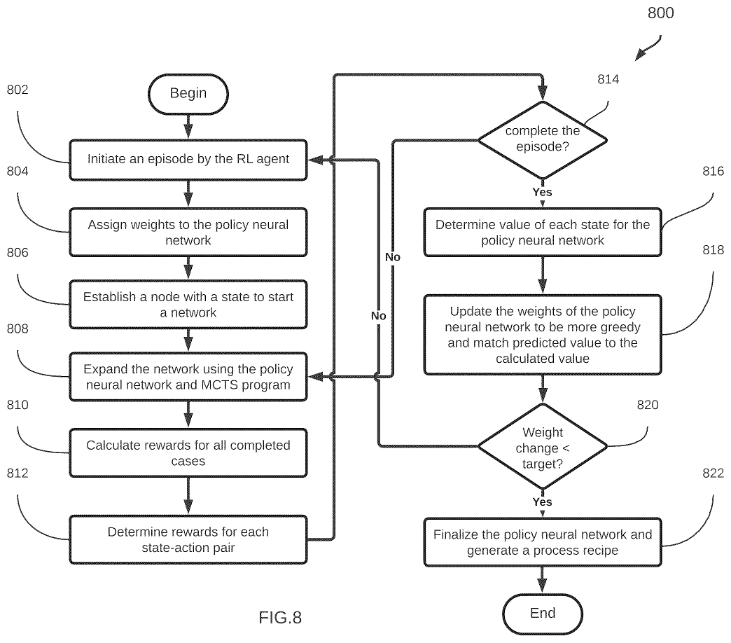

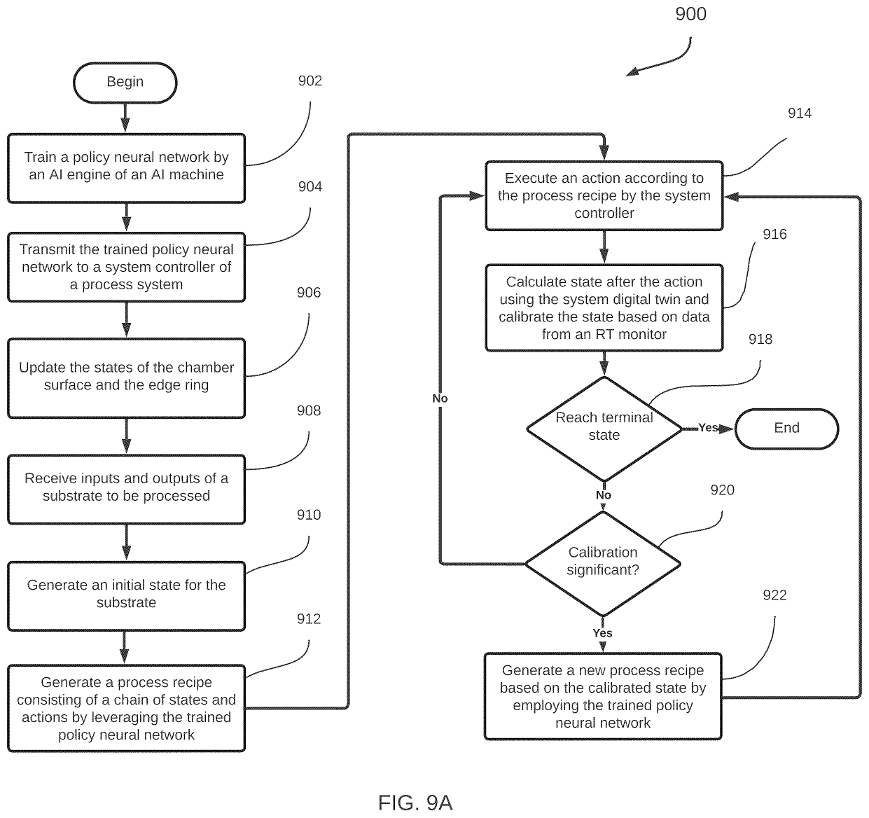

FIG. 8 showcases a flowchart for a process 800, which is a self-initiated process for autonomously generating a process recipe through an RL process. Process 800 starts with step 802, where the RL agent 224 initiates an episode for the RL process. An episode is represented by a network consisting of many nodes created by the MCTS program 228 enabled by the policy neural network 226. Each episode comprises many cases, wherein each case represents a completed simulation for a virtual process based on the system digital twin 140 or the fleet nominal digital twin 235. For example, a case for an ALE process leads to a completed ALE process reaching the terminal state. The structures on the substrate have met a set of criteria, such as reaching the targeted etching depth. This typically includes a chain of actions and multiple or many intermediate states. A completed episode should deliver the rewards associated with state-action pairs and the value of the nodes.

In step 804, initial weights are assigned to the policy neural network 226. In one implementation, the weights are assigned randomly. In another implementation, the weights are based on a previous RL episode, enabling continuous improvement which makes the policy neural network 226 generate more optimal actions to increase reward.

In step 806, an initial node for a network is established. The initial node is associated with an initial state which describes an incoming substrate with a set of parameters as listed exemplarily in Table 2. At this point in time, the RL agent 224 applies the policy neural network 226 to generate probability distributions of selected recipe parameters. Based on the probability distribution, the MCTS program 228 is employed to generate an action with determined recipe parameters. A random number generator is typically applied based on the distribution to generate the action. Subsequently, the RL agent 224 applies the action by leveraging the system digital twin 140 to generate the next node with a new state. The process repeats until a case is completed.

In step 808, the network is expanded progressively using the policy neural network 226 and the MCTS program 228. Each state-action pair of the network is associated with a visit count. Some state-action pairs are involved in more than one case, which is accounted for by the visit count.

In step 810, rewards are calculated based on the reward calculator 230 for all completed cases. If the state-action pair is involved in a specific case, it will receive the reward accordingly in step 812. The reward accumulates as the visit count is increased. The average reward for a specific state-action pair is the accumulated rewards divided by the visit counts of the state-action pair.

In step 814, the RL agent 224 gauges if the episode is completed. A decision may be made by evaluating nodes in the network and completed cases against selected recipe parameters/discrete levels. If the result is negative, the RL agent 224 continues to expand the network. Otherwise, the RL agent 224 determines the value for each state in step 816. For each node associated with the state, the RL agent 224 has established relationships between state-action pairs and their associated rewards. The value of the node based on the current policy neural network can be computed as an average of the reward across all the state-action pairs originating from the node.

In step 818, the RL agent 224 updates the weights of the policy neural network 226 based on all available state-action pairs. At each node, the state is an input for the policy neural network 226, and a set of softmax/logistic function parameters are the outputs. The output also includes the predicted value. The updated weights should make the policy neural network more focused on generating actions with higher value and predicting the value more accurately. As the policy neural network 226 improves, it should become more deterministic in selecting an action from a group of available actions to generate the highest reward. This becomes a typical classification problem, hence a cost function for updating the policy neural network 226 should include a cross-entropy loss function and a squared error function for the value. The policy neural network 226 can be trained by leveraging rewards associated with all actions from the node. In one implementation, the earlier nodes may carry heavier weight during training to be consistent with a discount rule.

Different surface conditions and edge ring heights can be used as inputs to train the policy neural network 226. Hence the network can be used for an accurate prediction after being transmitted to the system controllers of the process systems for the real-world applications.

In step 820, the RL agent 224 evaluates if the weights have converged and the changes of the weights by leveraging new training data become sufficiently small. If the result is negative, the RL agent 224 can initiate a new episode to repeat the process and generate more data through more exploration. In one implementation, an ε-greedy algorithm may be employed to encourage exploration against exploitation. In another implementation, a new set of initial weights for the policy neural network 226 may be applied. In yet another implementation, the weights generated from the previous episode may be used together with the ε-greedy algorithm.

If the evaluation in step 820 is positive, the policy neural network 226 is finalized in step 822. A process recipe can be generated accordingly. The finalized policy neural network 226 can be transmitted to the system controllers through the communication links. In a real-world processing using the process system 100, when a state is known after calibration, the policy neural network can be employed to generate the actions in real-time.

The trained policy neural network can be a result of more than one set of input and the output specifications. Since the training can be conducted in the background, a very large and deep neural network can be applied with a heavy data load. For example, a generic ALE policy neural network for inputs with different types of stacks and critical dimensions and profile requirements is possible. There will be a broad spectrum of the implementation from a specialized policy neural network for a specific application to a more generic policy neural network for several or more applications. All such variations will fall within the inventive concept of the present invention.

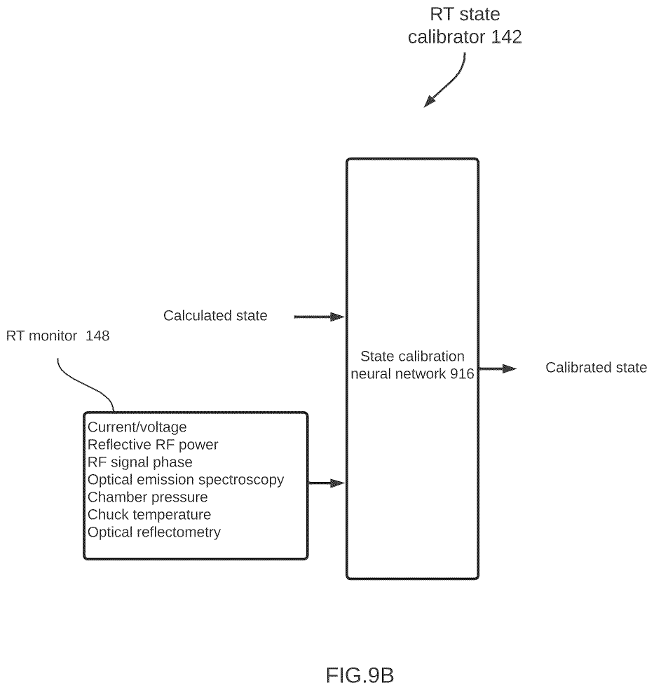

FIG. 9A showcases a flowchart describing a process for real-time calibration of a state and identification of subsystem parameters. Process 900 starts with step 902 where the AI engine 220 receives inputs, and output specifications for a substrate. In step 904, a policy neural network 226 is trained by the AI engine 220 of the AI machine 202. As a result, a trained policy neural network 144 is created. The trained policy neural network 144 is then transmitted from the AI machine 202 to the system controllers through the communication links. Upon receiving the trained policy neural network 144, the system controller 132 is ready to generate a process recipe for a substrate to be processed in the plasma process chamber 104.

In step 906, states of the chamber interior surface and the edge ring are updated using their digital twins, respectively. Herein, the ages of the surfaces and the edge ring being exposed to the plasma are the inputs of the digital twins 166 and 168 along with other parameters including parameters related to the cleaning procedures during the PM.

In step 908, the system controller 132 receives inputs, and output specifications of the substrate to be processed. An initial state of the substrate is generated in step 910, which utilizes a set of parameters to describe the structures of the incoming substrate. In step 912, a process recipe is generated by the system controller 132 using the trained policy neural network 144. The process recipe consists of a chain of actions.

In step 914, the system controller 132 executes an action according to the process recipe. For example, the action may be a cycle including the surface modification and the sputtering steps of an ALE process. In step 916, the state is calculated as a result of the action by the system controller.

The calculated state is subsequently calibrated using a state calibration neural network 916. The neural network 916 is a trained neural network. The training can be conducted based on both simulated and measured data. For example, an intermediate state can be calculated and compared with a measurement to train the neural network 916. Taking an ALE process as an example, a profile of the structure during the etching process can be predicted using the system digital twin 140. Subsequently, a transmission electron microscopy (TEM) technique is applied to a substrate pulled out from the plasma process chamber at the step to obtain a real-world profile of the structure. The difference between the real-world data and the simulated data serves as a set of training data for the neural network 916. In some other implementations, optical reflectometry techniques may be utilized to generate the real-world data.

As shown in FIG. 9B, the state calibration neural network 916 takes the calculated state as one of the inputs. It takes outputs of the RT monitor 148 as another input. The calibrated state is the output of the neural network 916. The RT monitor 148 includes various sensors as listed exemplarily in FIG. 9B. These include, but are not limited to, an IV probe for measuring RF current/voltage, an RF power sensor for measuring reflective RF power, phase sensors for measuring RF current or voltage phases, optical emission spectroscopy sensors for measuring neutral compositions inside the chamber, a manometer for chamber pressure, temperature sensors for measuring chuck temperature, and a sensor for an optical reflectometry technique for measuring the progression of the structures of the substrate.

In step 918, the system controller 132 evaluates if the terminal state has been reached based on the calibrated state. The terminal state represents the end point of the process. If the terminal state is reached, process 900 is completed. Otherwise, the system controller 132 evaluates in step 920 if the calibration of the state is significant enough to trigger step 922 to generate a new process recipe based on the calibrated state by employing the trained policy neural network 144. A squared error function can be constructed to measure the difference between the calculated and the calibrated state. The error function includes a selected set of parameters describing the state. If the normalized error is above a predefined target, the process recipe will be regenerated for the remaining process step.

In one implementation, the actions for the remaining process are generated at once. In another implementation, the action for the next step only is generated. The state will be calibrated, and the action will be generated step by step. At step 920, if the calibration is insignificant, steps 914 and 918 will be repeated until reaching the terminal state.

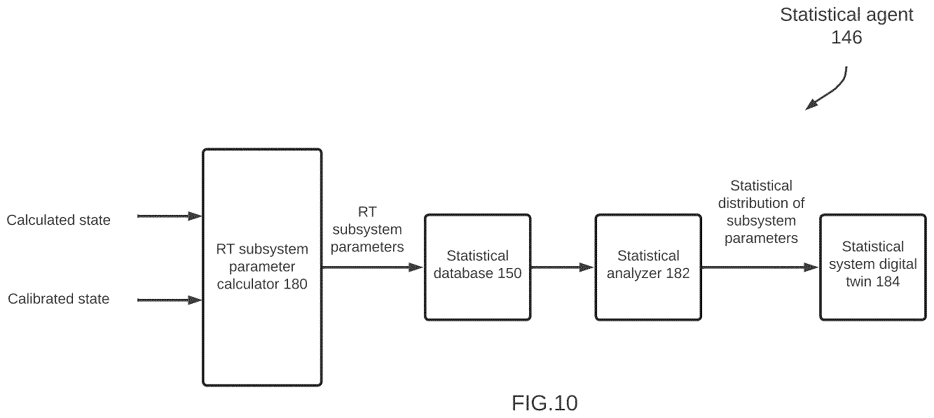

FIG. 10 depicts a flow diagram illustrating that a statistical agent 146 is employed to convert the system digital twin 140 into a statistical system digital twin 184. The digital twin 184 can be used to predict statistical distributions of the output parameters of the substrate. The statistical agent 146 takes calculated and calibrated states as its inputs. It applies an RT subsystem parameter calculator 180 to generate RT subsystem parameters. In one implementation, the calculator 180 is an optimization procedure that employs the system digital twin 140 to adjust a set of selected subsystem parameters to achieve the best fitting between the calculated and the calibrated state. The selected subsystem parameters may include multiple or all subsystems. The subsystem parameters may include the design parameters, such as the values of their components, and operating parameters like operating frequency and set points for the actuator for the valve atop the pump. A statistical database 150 is created to store the selected subsystem parameters provided by the calculator 180. The accumulated data in the database 150 is analyzed by a statistical analyzer 182. Statistical distributions of the subsystem parameters are generated and stored in the statistical database 150. A Monte Carlo algorithm can then be applied to generate many sets of inputs for the system digital twin 140, which generates many sets of output parameters for the substrate. The statistical analyzer 182 is utilized to capture statistical characteristics of the outputs.

It is important to note that systematic drifting of certain chamber parameters such as interior surface aging and the edge ring erosion have been captured by respective digital twins 166 and 168. Although such parameters are accompanied by random variations, the statistical agent 184 is focused on random variations rather than systematic changes.

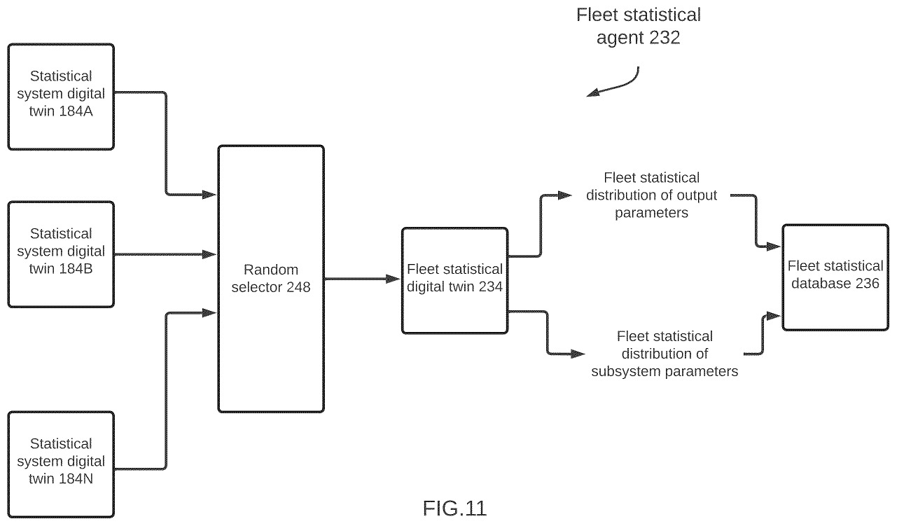

FIG. 11 illustrates schematically a flow diagram where a fleet statistical agent 232 is employed to establish a fleet statistical digital twin 234. The agent 232 leverages a plurality of process system-specific statistical system digital twins, labeled as 184A, 184B, and 184C, to construct the digital twin 234. At the first step, a random number generator 248 selects one process system from the fleet. Subsequently, the subsystem parameters are determined based on their statistical distributions, using additional random number generators, for the selected process system. The process of selection will be repeated many times for the process systems and the subsystem parameters. The simulations for process cases will be repeated many times to generate the output parameters distribution at the fleet level. Both the fleet statistical distributions of the output parameters and the statistical distribution of the subsystem parameters are recorded into a fleet statistical database 230. The recorded data are analyzed by a statistical analyzer to capture their statistical characteristics. Subsequently, the fleet nominal system digital twin 235 can be generated by applying nominal subsystem parameters to generate distributions of the output parameters.

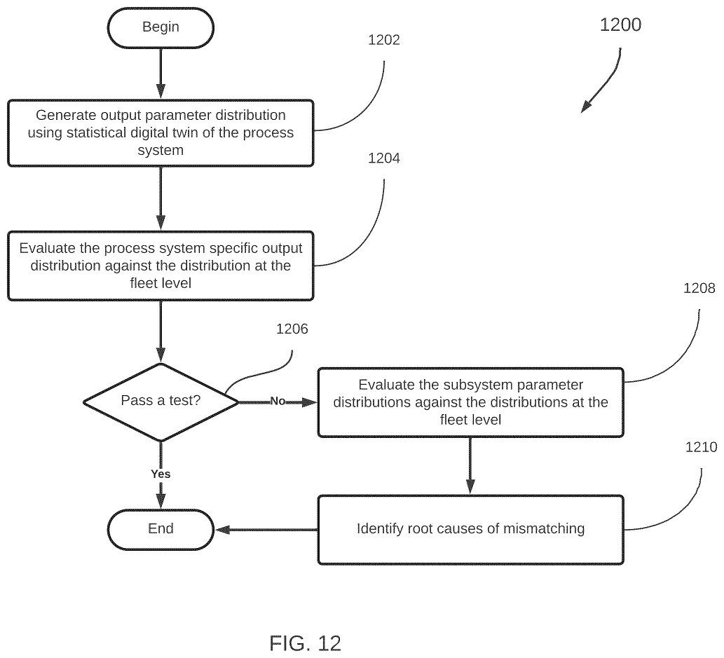

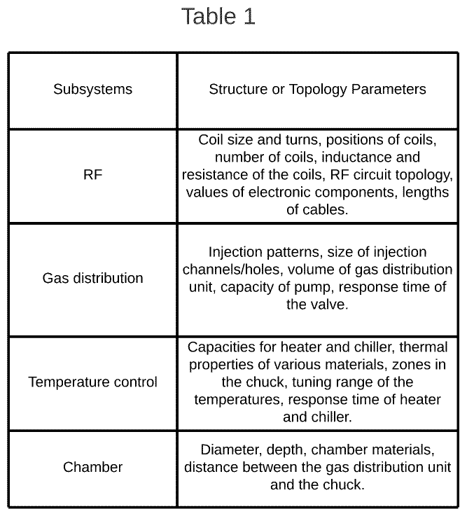

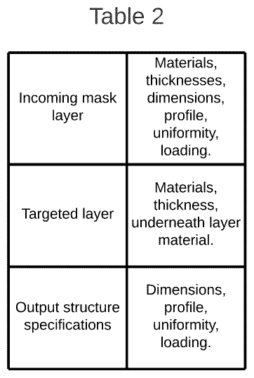

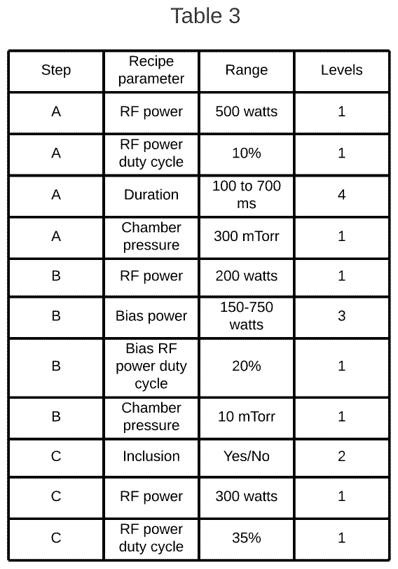

FIG. 12 showcases a flowchart to gauge if a process system is operated within the statistical distribution of the fleet. Process 1200 starts with step 1202 where a process system is selected, and output parameter distributions are generated based on the process system-specific statistical digital twin. The step 1202 can be carried out by either the system controller 132 or the AI machine 202. In step 1204, the AI machine 202 evaluates the process system-specific distributions against the fleet level distribution. In step 1206, the AI machine 202 gauges if the process system-specific distributions are within the fleet distributions. The tests for gauges if a subset of data follows the statistical distributions of a larger dataset are well established and known in the art. The commonly used statistical techniques include the Kolmogorov-Smirnov test, Chi-Square test, and Anderson-Darling test. If the test is passed, the process 1200 ends. Otherwise, in step 1208, the AI machine 202 evaluates the subsystem parameter distribution of the specific process system against the distributions at the fleet level. The AI machine 202 identifies root causes of mismatching in step 1210 and ends process 1200.

1. A control module for a semiconductor process system, comprising:
a plurality of subsystem controllers for controlling operations of a plurality of subsystems;
a trained policy neural network for autonomously generating a process recipe by leveraging a system digital twin, wherein the policy neural network includes a chain of actions for transforming a substrate from one state to another state, wherein the state is a description of structures in the substrate; and
a system controller for calibrating calculated state by leveraging a RT monitor including a plurality of sensors, wherein a statistical agent generates a statistical database which includes statistical distribution of subsystem parameters by leveraging the differences between the calculated and the calibrated state.

2. The control module of claim 1, wherein the trained policy neural network is transmitted from an AI machine through a communication link, wherein the AI machine is a controller for a fleet of process systems.

3. The control module of claim 2, wherein the AI machine further includes an AI engine for training the policy neural network through an RL process.

4. The control module of claim 3, wherein the AI engine further includes an AI engine controller, an RL engine, a fleet statistical agent, a fleet system digital twin and a fleet statistical database, wherein the fleet statistical agent leverages digital twins of a plurality of process systems and associated statistical databases to generate statistical distributions of output parameters of the substrate for the fleet of the process systems.

5. The control module of claim 1, wherein the statistical distributions of the output parameters of the process system are evaluated by the fleet statistical agent of the AI machine to gauge if the process system is within the statistical distributions of the fleet.

6. The control module of claim 1, wherein the system digital twin further includes an RF digital twin, a gas digital twin, a temperature digital twin, a chamber plasma digital twin, a chamber surface aging digital twin, an edge ring digital twin, and a process digital twin.

7. The control module of claim 4, wherein the RL engine further includes an RL agent, an MCTS program, and a reward calculator.

8. The control module of claim 1, wherein the policy neural network includes an input layer, multiple hidden layers, and an output layer, wherein the output layer comprises multiple parts, each part providing outputs that describe probability distributions of selected process recipe parameters using softmax and/or logistic functions across various discretized levels.

9. The control module of claim 1, wherein the RT monitor further includes a plurality of sensors for measuring parameters of subsystems, parameters of plasma inside a plasma process chamber, and parameters for the substrate structures.

10. The control module of claim 1, wherein the control module is a part of etching or deposition process systems.

11. An AI machine for a fleet of process systems, comprising:
a plurality of hardware and software modules optimized for AI applications; and
an AI engine built upon the hardware and software modules,
wherein the AI engine autonomously trains a policy neural network through an RL process,
wherein the trained policy neural network is transmitted to a system controller of a process system for generating and adjusting a process recipe in real-time based on data provided by an RT monitor,
wherein the AI engine develops a fleet level system digital twin for gauging if a selected process system is operated within statistical distributions of the fleet.

12. The AI machine of claim 11, wherein the process system further comprises a system controller for receiving the trained policy neural network from the AI machine, wherein the system controller generates an action in real-time by leveraging the trained policy neural network and data provided by an RT monitor comprising a plurality of sensors.

13. The AI machine of claim 12, wherein the system controller employs a statistical agent to generate a statistical database which stores statistical distributions of selected subsystem parameters by leveraging differences between a calculated state and a calibrated state, wherein the state is a description of structures in a substrate being processed.

14. The AI machine of claim 11, wherein the policy neural network includes an input layer, multiple hidden layers, and an output layer, wherein the output layer comprises multiple parts, each part providing outputs that describe probability distributions of selected process recipe parameters using softmax and/or logistic functions across various discretized levels.

15. The AI machine of claim 11, wherein the RT monitor further includes a plurality of sensors for measuring parameters of subsystems, parameters of plasma inside a plasma process chamber, and parameters for structures in a substrate.

16. A method for controlling a fleet of process systems, comprising:
a) generating output parameter statistical distributions of a process system by using a statistical digital twin of the process system;
b) evaluating the distributions against statistical distributions of the same set of the output parameters for the fleet;
c) gauging if the distributions from the process system are within the distributions of the fleet; and
d) identifying responsible subsystem parameters if the distributions from the process system are beyond the distributions of the fleet.

17. The method of claim 16, wherein the method further comprises generating a fleet level statistical system digital twin by a fleet statistical agent through a plurality of statistical system digital twins of the process systems by using random number generators to select a process systems and the related subsystem parameters according to their statistical distributions.

18. The method of claim 16, wherein the method further includes storing the distributions from the process system in a statistical database.

19. The method of claim 16, wherein the method further includes storing the output distribution of the fleet in a fleet statistical database.

20. The method of claim 16, wherein the process system further includes an etching or a deposition process system.
